(19) United States
(12) Patent Application Publication
(10) Pub. No.: US 2003/0024344 A1
(43) Pub. Date: Feb. 6, 2003

(54) Structure of car pedal

(76) Inventor: Yao-Huang Liu, Taichung (TW)

Correspondence Address: Yao-Huang Liu, 58, MA YUAN WEST ST., TAICHUNG, TW

(21) Appl. No.: 09/887,990

(22) Filed: Jun. 21, 2001

(51) Int. Cl. G05G 1/16

(52) U.S. Cl. 74/563; 74/560

(57) ABSTRACT

In one embodiment of the present invention, a car pedal comprises a pedal, an anti-slip plate, and a tread plate. The anti-slip plate, made of rubber or plastics, is secured near the front end of the pedal by rivets. The periphery of the anti-slip plate forms an inner groove into which the tread plate, made of stainless steel or aluminum alloy, is fitted. A plurality of colored anti-slip protrusions are disposed on the upper surface of the anti-slip plate. They correspond to a plurality of holes provided on the tread plate. Thus, the colored anti-slip protrusions go through the holes of the tread plate and protrude from the metallic surface of the tread plate fitted on the anti-slip plate. In another embodiment of the present invention, the above anti-slip plate is omitted, the colored anti-slip protrusions are disposed on the upper surface of the pedal, and the tread plate is secured near the front end of the pedal by rivets.

### FIELD OF THE INVENTION

The present invention relates to a pedal and especially to an improved structure of a car pedal for use in an accelerator, a brake, a clutch, etc.

### BACKGROUND OF THE INVENTION

For example, a commercially available car pedal is shown in FIG. 1, which is a perspective view of the pedal. The pedal 1 is provided with several anti-slip protrusions 2 near its front end, which are regularly disposed or form a pattern of trademarks. The anti-slip protrusions 2 are generally injection-molded integrally with the pedal 1 in order to provide the latter with the anti-slip property. Such a pedal has several drawbacks as described below.

1. Since the anti-slip protrusions 2 are injection-molded integrally with the pedal 1, the variety of the anti-slip protrusions 2 is limited.

2. Although the cost for producing such a pedal is low, its appearance is unrelieved and unattractive.

3. Since the anti-slip protrusions 2 is consistent with the pedal 1 in terms of color, this is also unfavorable in view of decorative value.

Thus, there is a need to improve conventional car pedals and to add value to them.

### SUMMARY OF THE INVENTION

The objective of the present invention is to provide an improved structure of a car pedal that has no the drawbacks as described above.

In one embodiment of the present invention, a car pedal comprises a pedal, an anti-slip plate, and a tread plate. The anti-slip plate, made of rubber or plastics, is secured near the front end of the pedal by rivets. The periphery of the anti-slip plate forms an inner groove into which the tread plate, made of stainless steel or aluminum alloy, is fitted. A plurality of colored anti-slip protrusions are disposed on the upper surface of the anti-slip plate. They correspond to a plurality of holes provided on the tread plate. Thus, the colored anti-slip protrusions go through the holes of the tread plate and protrude from the metallic surface of the tread plate fitted on the anti-slip plate.

In another embodiment of the present invention, the above anti-slip plate is omitted. The colored anti-slip protrusions are disposed on the upper surface of the pedal. The tread plate is secured near the front end of the pedal by rivets.

### BRIEF DESCRIPTION OF THE DRAWINGS

The above and other objectives, features and advantages of the invention will become apparent from the following detailed description of preferred embodiments in connection with the accompanying drawings in which:

FIG. 1 is a perspective view of a conventional car pedal.

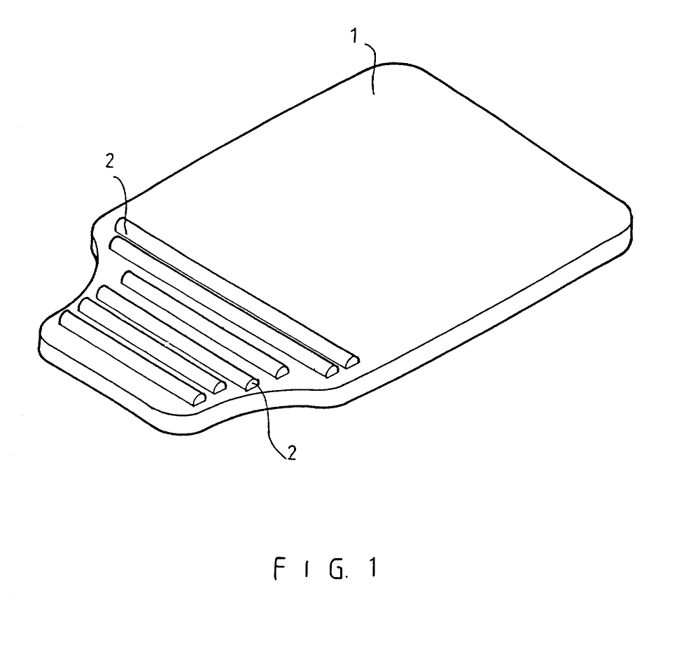

FIG. 2 is an exploded view of a car pedal in accordance with one embodiment of the present invention.

FIG. 3 is a perspective view of the car pedal shown in FIG. 2.

FIG. 4 is a side sectional view of the car pedal shown in FIG. 3.

FIG. 5 is an exploded view of a car pedal in accordance with another embodiment of the present invention.

FIG. 6 is a perspective view of the car pedal shown in FIG. 5.

FIG. 7 is a side sectional view of the car pedal shown in FIG. 6.

It is noted that the drawings of the invention are not to scale. The drawings are merely schematic representations, not intended to portray specific parameters of the invention, rather to illustrate the principles of the invention. The drawings are intended to depict only a typical embodiment of the invention and therefore should not be considered as limiting the scope of the invention.

Reference Numerals of the Elements in the Drawings

| | |
|---|---|
| 1 | pedal |
| 2 | anti-slip protrusion |
| 3 | pedal |
| 4 | rivet |
| 5 | hole |
| 6 | trademark base |
| 7 | tread plate |
| 8 | anti-slip protrusion |
| 9 | hole |
| 10 | anti-slip plate |
| 11 | hole |
| 12 | tappet |
| 13 | hole |
| 14 | inner groove |
| 15 | hole |

### DETAILED DESCRIPTION OF THE PREFERRED EMBODIMENT

Two car pedals will be described below as preferred embodiments of the present invention. It should be understood, however, that the present disclosure is to be considered as an exemplification of the principles of this invention and is not intended to limit the invention to the illustrated embodiments.

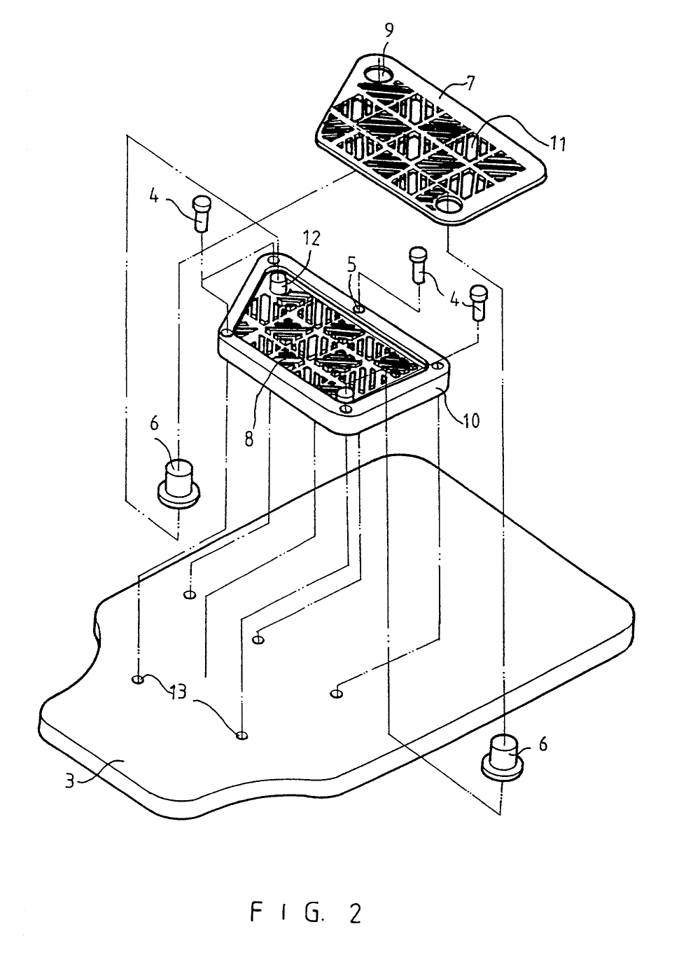

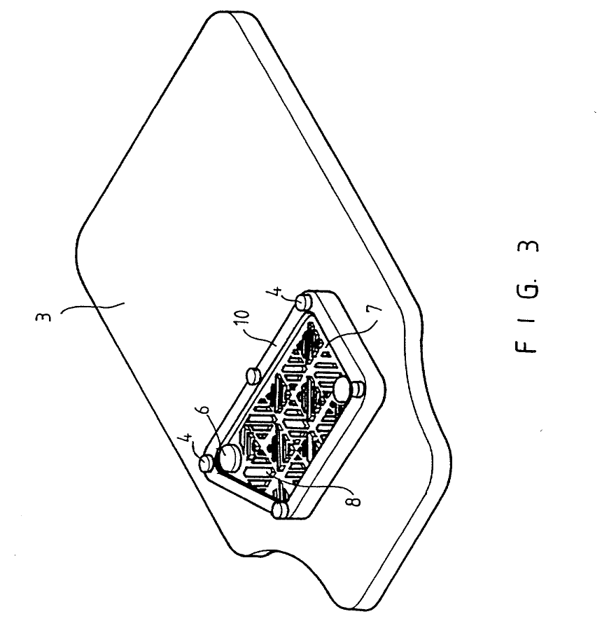

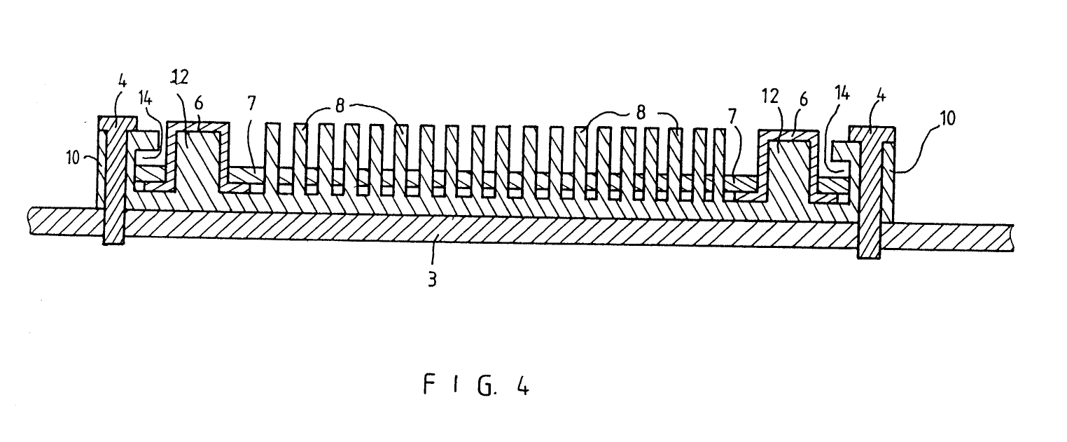

FIGS. 2, 3, and 4 are an exploded view, a perspective view, and a side sectional view of a car pedal in accordance with one embodiment of the present invention, respectively.

As shown in FIGS. 2, 3, and 4, a car pedal comprises a pedal 3, an anti-slip plate 10, and a tread plate 7. The anti-slip plate 10, made of rubber or plastics, has five holes 5 near its periphery, which respectively correspond to five holes 13 provided on the pedal 3. Thus, the anti-slip plate 10 is secured near the front end of the pedal 3 by rivets 4 through holes 5 and 13.

The periphery of the anti-slip plate 10 extends slightly upward and inward in such a manner that an inner groove 14 is formed therein. The tread plate 7, made of stainless steel or aluminum alloy, is fitted into the inner groove 14 of the anti-slip plate 10.

A plurality of colored anti-slip protrusions 8 are disposed on the upper surface of the anti-slip plate 10. The anti-slip protrusions 8 can be regularly distributed or form a desired pattern and they correspond to a plurality of holes 11 provided on the tread plate 7. Thus, the colored anti-slip protrusions 8 go through the holes 11 of the tread plate 7 and protrude from the metallic surface of the tread plate 7 fitted on the anti-slip plate 10.

Furthermore, two tappets 12 are diagonally disposed on the anti-slip plate 10. The tappets 12 are implanted with two trademark bases 6 and then go through two holes 9 provided on the tread plate 7.

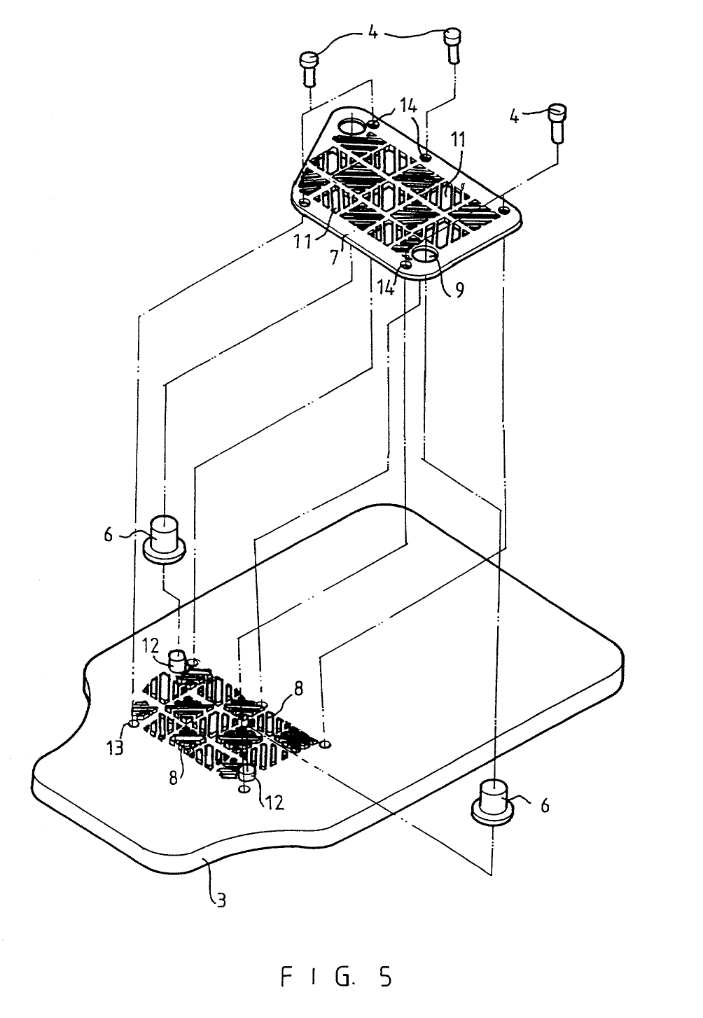

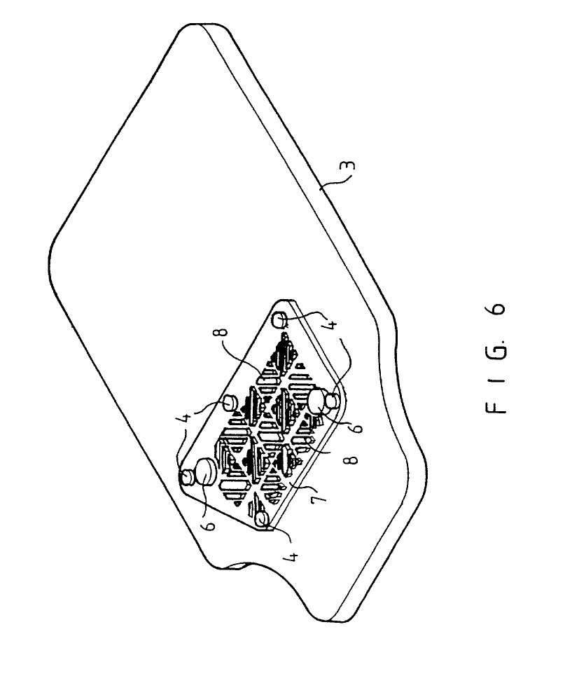

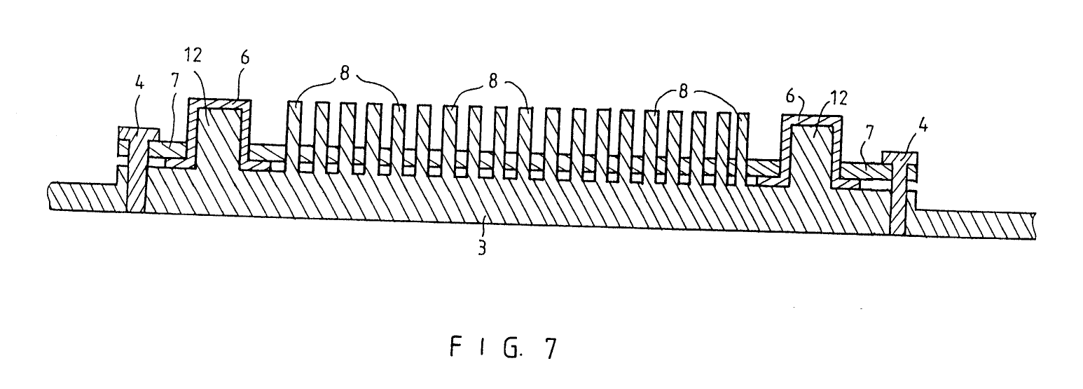

FIGS. 5, 6, and 7 are an exploded view, a perspective view, and a side sectional view of a car pedal in accordance with another embodiment of the present invention, respectively.

As shown in FIGS. 5, 6, and 7, a car pedal comprises a pedal 3 and a tread plate 7. The tread plate 7 has five holes 15 near its periphery, which respectively correspond to five holes 13 provided on the pedal 3. Thus, the tread plate 7 is secured near the front end of the pedal 3 by rivets 4 through holes 13 and 15.

A plurality of colored anti-slip protrusions 8 is disposed on the pedal 3. The anti-slip protrusions 8 can be regularly distributed or form a desired pattern and they correspond to a plurality of holes 11 provided on the tread plate 7. Thus, the colored anti-slip protrusions 8 go through the holes 11 of the tread plate 7 and protrude from the surface of the tread plate 7 secured on the pedal 3.

Furthermore, two tappets 12 are diagonally disposed on the protrusion region of the pedal 3. The tappets 12 are implanted with two trademark bases 6 and then go through two holes 9 provided on the tread plate 7. The anti-slip protrusions 8 and the tappets 12 can be injection-molded integrally with the pedal 3.

The car pedal in accordance with the present invention has the advantages as listed below.

1. Since the colors of the pedal 3, the anti-slip plate 10, and the tread plate 7 can be flexibly designated, it is possible to largely improve the interior decoration of a car.

2. The pattern formed by the anti-slip plate 10 (anti-slip protrusions 8) not only provides the pedal 3 with the anti-slip property but also has decorative value.

3. Since the low cost for production, the ease in assembling, and the unlimited variety of the anti-slip protrusions, such a car pedal has a-great commercial potential.

While the invention has been described with specific reference to the embodiments, someone skilled in the art will recognize that changes can be made in form and detail without departing from the spirit and the scope of the invention. All changes that come within the meaning and range of equivalency of the claims are to be embraced within their scope.

What is claimed is:

1. An improved structure of a car pedal, comprising a pedal, a anti-slip plate, and a tread plate;
wherein said anti-slip plate, made of rubber or plastics, has five holes near its periphery, which respectively correspond to five holes provided on said pedal, thereby said anti-slip plate being secured near the front end of said pedal by rivets through these holes;
wherein the periphery of said anti-slip plate extends slightly upward and inward in such a manner that a inner groove is formed therein, thereby said tread plate, made of stainless steel or aluminum alloy, being fitted into said inner groove of said anti-slip plate;
wherein a plurality of colored anti-slip protrusions are disposed on the upper surface of said anti-slip plate, and said anti-slip protrusions are regularly distributed or form a desired pattern and they correspond to a plurality of holes provided on said tread plate, thereby said colored anti-slip protrusions going through said holes of said tread plate and protruding from the metallic surface of said tread plate fitted on said anti-slip plate; and
wherein, two tappets are diagonally disposed on said anti-slip plate, thereby said tappets being implanted with two trademark bases and then going through two holes provided on said the tread plate.

2. An improved structure of a car pedal, comprising a pedal and a tread plate;
wherein said tread plate has five holes near its periphery, which respectively correspond to five holes provided on said pedal, thereby said tread plate being secured near the front end of said pedal by rivets through these holes;
wherein a plurality of colored anti-slip protrusions are disposed on said pedal, and said anti-slip protrusions are regularly distributed or form a desired pattern and they correspond to a plurality of holes provided on said tread plate, thereby said colored anti-slip protrusions going through said holes of said tread plate and protruding from the surface of said tread plate secured on said pedal;
wherein, two tappets are diagonally disposed on the protrusion region of said pedal, thereby said tappets being implanted with two trademark bases and then going through two holes provided on said tread plate; and
wherein said anti-slip protrusions and said tappets are injection-molded integrally with said pedal.
